(19) United States
(12) Patent Application Publication
(10) Pub. No.: US 2025/0199518 A1
(43) Pub. Date: Jun. 19, 2025

(54) SYSTEMS AND METHODS FOR DATA SYNCHRONIZATION VIA EDGE COMPUTING

(71) Applicant: Solar Turbines Incorporated, San Diego, CA (US)

(72) Inventors: Matthieu Subrin, Carabbia (CH); Roberto Camboni, Germignaga (IT); Gennaro Abbatiello, Verscio (CH); Fabio Cabella, Lodano (CH)

(21) Appl. No.: 18/544,373

(22) Filed: Dec. 18, 2023

(51) Int. Cl. G05B 19/418

(52) U.S. Cl. CPC G05B 19/4185; G05B 19/4188

(57) ABSTRACT

The present disclosure is directed to systems and methods for data synchronization by an edge computing device. The method includes (1) receiving, by a feedback loop interface, a request for an update of a data set via a data-acquisition-and-computing (DAC) engine in an edge computing device, (2) transmitting, by the feedback loop interface, the request for the update of the data set to an actor node in a network; (3) receiving, by the feedback loop interface, an indication regarding the update of the data set from the actor node; and (4) transmitting, by the feedback loop interface, the indication regarding the update of the data set via the DAC engine in the recurring cycle. The DAC engine includes a synchronizer to control sequences in a recurring cycle of the network. The synchronizer communicates with a configuration manager or receives configuration information from network nodes for managing the data set.

### TECHNICAL FIELD

The present technology is directed to systems and methods for data acquisition and synchronization for industrial machines, vehicles, and devices. More particularly, systems and methods for acquiring, synchronizing, normalizing, and/or dynamically updating or configuring a sourcing data set (e.g., adding an additional data source or remove an existing data source) in an edge computing environment for managing the industrial machines, vehicles, and devices.

### BACKGROUND

Machines and devices are used to perform various operations in different industries, such as power generation, compression stations, construction, mining, and transportation. Operations of these machines and devices involve various types of data and information. Such data and information can change from time to time and thus it is critical to acquire and update such data and information in an effective manner, such that computation based on such data and information is current and does not need to be redone again. Traditional approaches include synchronizing data from multiple data sources. For example, U.S. Pat. No. 9,423,822 (Singh) is directed to methods for synchronizing multiple data acquisition modules so as to facilitate analysis of signals captured by sensors coupled to those data acquisition modules. Singh's “synchronization” process is simply discarding certain data points without further details. The traditional approaches, including Singh, fail to disclose or suggest how to perform a data synchronization process timely and effectively. Therefore, it is advantageous to have an improved method and system to address the foregoing needs.

### SUMMARY OF THE INVENTION

The present technology is directed to systems and methods for data acquisition and synchronization. The present system includes a synchronizer (which operates in a real-time or near real-time manner) configured to manage multiple actor nodes of a network regarding signaling, sequencing, ordering, prioritizing, etc. The synchronizer processes (see, e.g., FIG. 8) these actor nodes in a recurring cycle within a short period of time (e.g. 0.001-1 second or eventually more). In some embodiments, dependencies of these actor nodes can be set by configuration manager and/or the synchronizer such that the synchronizer can orchestrate and manage the dependencies of these actor nodes (e.g., manage roles of these nodes and/or order of dependent nodes) in the network. For example, the actor nodes can be a producer node (PN), an asset association node (AAN) (e.g., in some instances, an asset can include a logical grouping or collection of data), a computing node (CPN), or a consumer node (CSN). The present system also includes a configuration manager (which does not operate in a real-time or near real-time manner) configured to manage data update configuration, nodes configuration, idle/active/inactive statuses of the multiple actor nodes of the network. In some embodiments, the system can also include a data interface to work with the actor nodes network configured by the configuration manager and support the data flowing through the actor nodes. In some embodiments, the synchronizer and the configuration manager can be integrally implemented in a device. In other embodiments, however, the synchronizer and the configuration manager can be implemented in separated devices.

The present technology is directed to a non-transitory, computer-readable storage medium storing instructions which, when executed by at least one data processor of a computing system, cause the computing system to: (1) receive, by a feedback loop interface, a request for an update of a data set via a data-acquisition-and-computing (DAC) engine in an edge computing device, wherein the DAC engine includes a synchronizer configured to control sequences in a recurring cycle of a network, and wherein the synchronizer is configured to communicate with actor nodes of the network configured by a configuration manager for managing the data set; (2) transmit, by the feedback loop interface, the request for the update of the data set to an actor node in the network; (3) receive, by the feedback loop interface, an indication regarding an action performed by the actor node such as the update of the data set from the actor node; and (4) transmit, by the feedback loop interface, the indication regarding the action performed by the actor node such as the update of the data set via the DAC engine in the recurring cycle.

One aspect of the present technology includes a system having a processor and a memory communicably coupled to the processor. The memory includes computer executable instructions that, when executed by the processor, cause the system to: (i) receive a request for an update of a data set via a data-acquisition-and-computing (DAC) engine in an edge computing device, wherein the DAC engine includes a synchronizer configured to control sequences in a recurring cycle of a network, and wherein the synchronizer is configured to communicate with actor nodes of the network configured by configuration manager for managing the data set via a data interface; (ii) transmit the request for the update of the data set to an actor node in the network; (iii) receive an indication regarding an indication regarding an action performed by the actor node such as the update of the data set from the actor node; and (iv) transmit the indication regarding the update of the data set via the DAC engine in the recurring cycle.

Another aspect of the present technology includes a method for data acquisition and synchronization. The method includes: (A) receiving, by a feedback loop interface, a first request for a first update of a first data set via a data-acquisition-and-computing (DAC) engine in an edge computing device; (B) receiving, by the feedback loop interface, a second request for a second update of a second data set via the DAC engine in the edge computing device, wherein the DAC engine includes a synchronizer configured to control sequences in a recurring cycle of a network, and wherein the synchronizer is configured to communicate with actor nodes of the network configured by a configuration manager for managing the first and second data sets; (C) transmitting, by the feedback loop interface, the first request for the first update of the first data set to a first actor node in the network; (D) transmitting, by the feedback loop interface, the second request for the second update of the second data set to a second actor node in the network; (E) receiving, by the feedback loop interface, a first indication regarding the first update of the first data set from the first actor node; (F) receiving, by the feedback loop interface, a second indication regarding the second update of the second data set from the second actor node; (G) transmitting, by the feedback loop interface, the first indication regarding the first update of the first data set to the synchronizer of the DAC engine; and (H) transmitting, by the feedback loop interface, the second indication regarding the second update of the second data set to the synchronizer of the DAC engine. In some implementations, the synchronizer is configured to transmit a confirmation (or an update request) to a third actor node indicating that the first update and the second update are complete, in response to the first status and the second status. In some implementations, the data set can be generated from a sensor of a turbine.

### BRIEF DESCRIPTION OF THE DRAWINGS

Non-limiting and non-exhaustive examples are described with reference to the following figures.

FIG. 1 is a schematic diagram illustrating nodes and their functions/roles in accordance with embodiments of the present technology.

FIGS. 2A and 2B are schematic diagrams illustrating node operations/actions in accordance with embodiments of the present technology.

FIG. 3 is a schematic diagram illustrating a data-acquisition-and-computing (DAC) engine in accordance with embodiments of the present technology.

FIG. 4A is a schematic diagram illustrating operations of a feedback loop interface for a single actor node (AN) in accordance with embodiments of the present technology.

FIG. 4B-4D are schematic diagrams illustrating use cases in accordance with embodiments of the present technology.

FIG. 5 is a schematic diagram illustrating operations of a feedback loop interface for multiple actor nodes (ANs) in accordance with embodiments of the present technology.

FIG. 6 is a schematic diagram illustrating components in a computing device (e.g., an edge computing device) in accordance with embodiments of the present technology.

FIG. 7 is a flow diagram showing a method in accordance with embodiments of the present technology.

FIG. 8 is a flow diagram showing operations of a synchronizer or a sampler in accordance with embodiments of the present technology.

### DETAILED DESCRIPTION

Various aspects of the disclosure are described more fully below with reference to the accompanying drawings, which form a part hereof, and which show specific exemplary aspects. Different aspects of the disclosure may be implemented in many different forms and the scope of protection sought should not be construed as limited to the aspects set forth herein. Rather, these aspects are provided so that this disclosure will be thorough and complete, and will fully convey the scope of the aspects to those skilled in the art. Aspects may be practiced as methods, systems, or devices. Accordingly, aspects may take the form of a hardware implementation, an entirely software implementation, or an implementation combining software and hardware aspects. The following detailed description is, therefore, not to be taken in a limiting sense.

The present technology is directed to systems and methods for processing data for operating machines, vehicles, or other suitable devices. More particularly, systems and methods for acquiring, synchronizing, normalizing, and/or dynamically updating or configuring a sourcing data set (e.g., adding an additional data source or remove an existing data source) in an edge computing environment are disclosed. In some embodiments, the present system includes an edge device having a data-acquisition-and-computing (DAC) engine. Embodiments of the edge device can include for example, a machine, a computer, a client device, a server device, an appliance, a computing device that is capable of pulling data from various data sources and processing the data, etc.

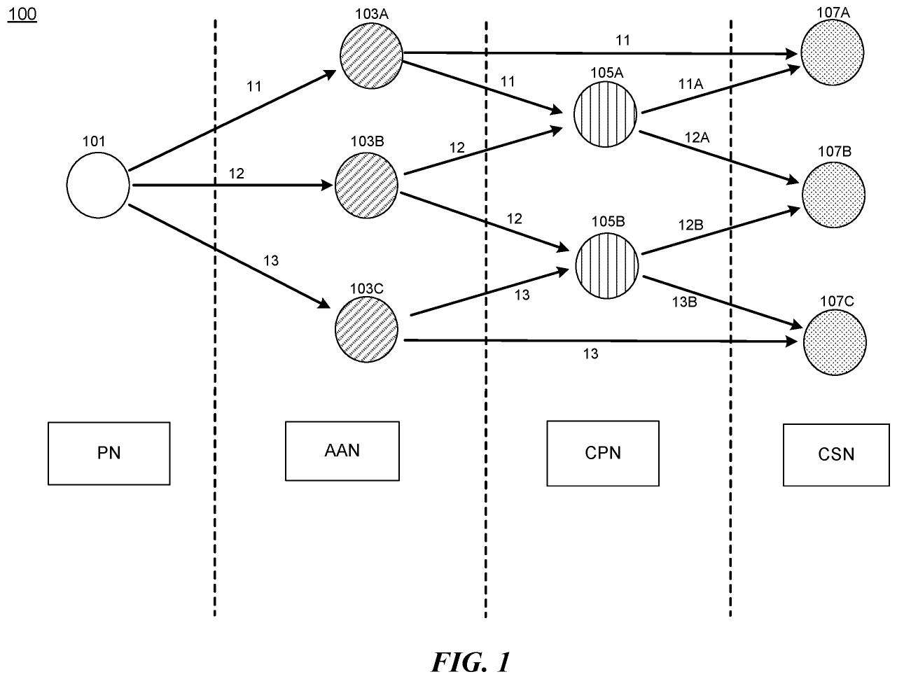

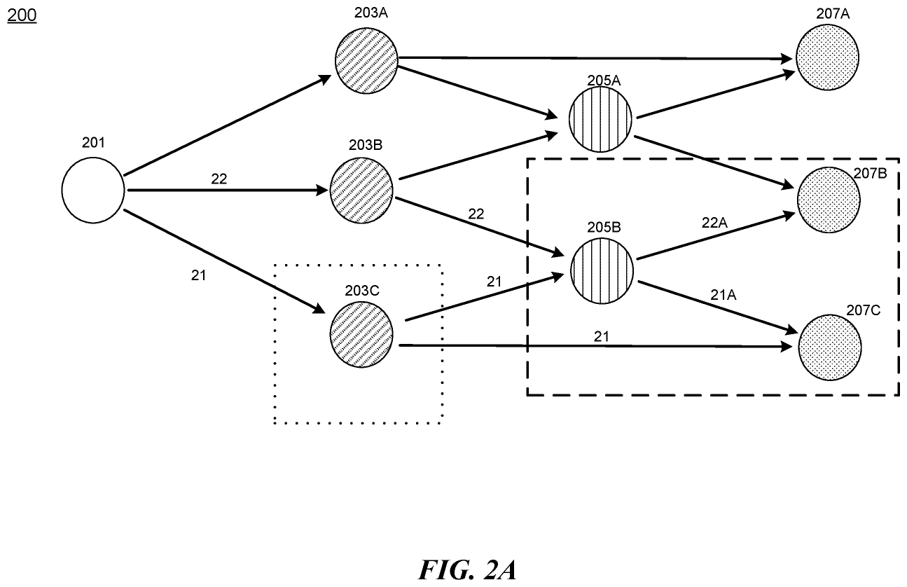

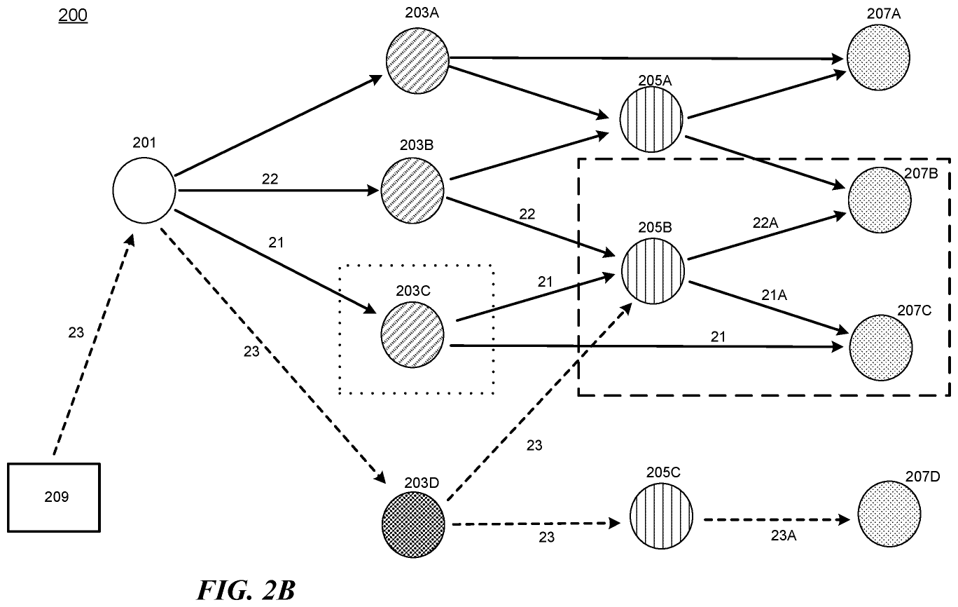

The DAC engine can communicate with multiple data sources (e.g., multiple machines in a work site, vehicles traveling in certain routes, devices operating in a designated area, devices connected via a network, etc.) and pull data or in some instances also be configured to receive data from these data sources. The DAC engine can also check updates of the data and make sure that the pulled data is current. The DAC engine is also configured to communicate with and manage multiple “Actor Nodes” or “Node Actors” in a network. In some embodiments, the “Actor Node” refers to a node (e.g., an edge device, machine, a computer, machine, vehicle, etc.) that performs a specific action (e.g., pulling/calculating/processing data, etc.). Embodiments of the actions that a node can perform are discussed in detail with reference to FIGS. 1, 2A, and 2B.

In some embodiments, the DAC engine includes a synchronization or sampler module configured to communicate with and manage multiple “actor nodes.” In some embodiments, the actor nodes can include an entity or a device/machine/vehicle/appliance that performs a specific action in response to a data update and/or a data update request/command. For example, the actor nodes can include at least four different roles, such as (1) “producer node,” (2) “asset association node” (3) “computing node,” and (4) “consumer node.”

More particularly, for example, the “producer node” can pull or eventually receive data from data sources and the DAC Engine will make the data processed into different “asset association nodes.” In some embodiments, there can be one or more data normalization/scaling processes performed in the “asset association node.” The processed data can then be further computed at the “computing node” to elaborate and generate data for the “consumer node” to use.

In an illustrated example, Machine A (e.g., an excavator in a mining site) has a sensor measuring a temperature T. Producer Node PN-A (e.g., an edge device attached to Machine A) for Machine A can retrieve temperature T as input and generate corresponding normalized data (e.g., a number from 0 to 1; “0” means 10° C. and “1” means 200° C.). Machine B has another sensor measuring an emission E (e.g., a concentration of a particular chemical, ppm, etc.) of Machine B. Producer Node PN-B for Machine B can retrieve data associated with emission E as input and generate corresponding normalized data (e.g., a number from 10 to 100; “10” means 100 ppm and “100” means “10000 ppm”).

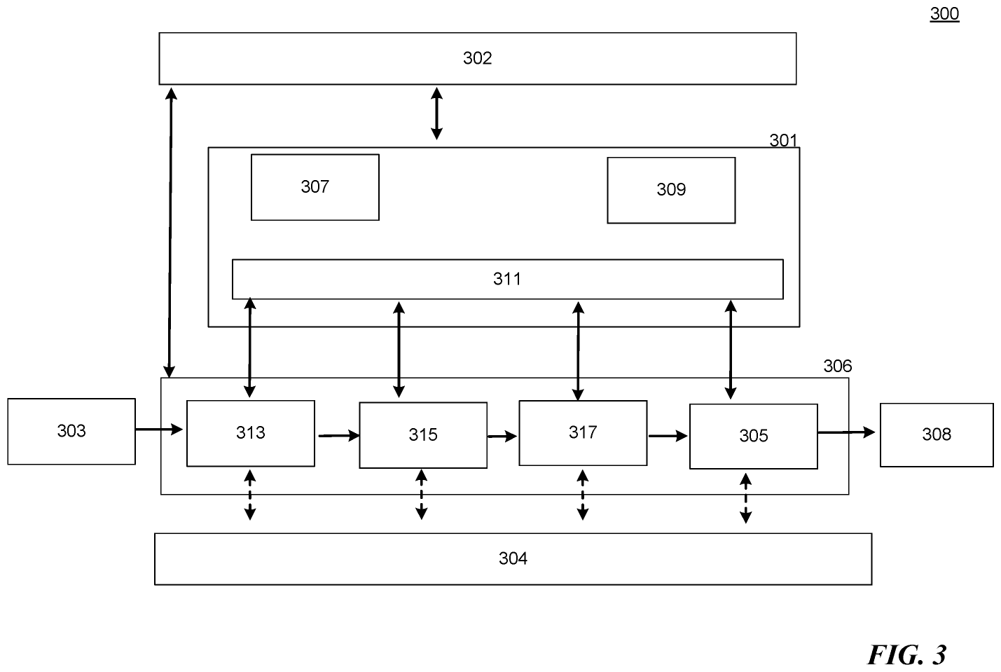

The DAC engine (e.g., a synchronizer, sampler, or synchronization/sampler module) knows dependencies of the network nodes. For example, the DAC engine knows that a first Consumer Node CSN-1 (e.g., an emission control site) needs both temperature T and emission E to complete its emission control task. There can be a second Consumer Node CSN-2 (e.g., a machine operation monitor) that only needs temperature T to perform its task (e.g., monitoring the operation of Machine A). Embodiments of the DAC engine are discussed in detail with reference to FIGS. 3-5.

Consumer Nodes CSN-1 and CSN-2 can be associated with Asset Association Node AAN (because they both need updated data for temperature T to complete their tasks). The Asset Association Node AAN is also configured to perform one or more data normalization/scaling processes on the associated data. In some embodiments, the Asset Association Node AAN can also be configured to adjust the format, range, type, etc. of the data in a suitable manner.

In the foregoing example, a first Computing Node CPN-1 can be configured to perform processing updated information of temperature T for the first Consumer Node CSN-1 (e.g., calculating an estimate emission rate based on temperature T and emission E). A second Computing Node CPN-2 can be configured to perform processing updated information of temperature T for the second Consumer Node CSN-2 (e.g., using temperature T as an input of a machine monitoring model). In some embodiments, the first Computing Node CPN-1 and the second Computing Node CPN-2 can be implemented as computer instructions or applications.

When there is a change to or an update for temperature T (e.g., a 2-degree Celsius increase of temperature T within 1 second), the change will be capture during a triggered process to update all the DAC Engine nodes of the network (or the network nodes). During the update process, in some embodiments, the DAC engine synchronizer first communicates with Asset Association Node AAN to learn that the first Computing Node CPN-1 and the second Computing Node CPN-2 will be affected by the update cycle. The DAC engine (e.g., synchronizer) can then communicate with the first Computing Node CPN-1 and the second Computing Node CPN-2 to trigger their calculation or computation associated with temperate T, after an updated temperature T is available upstream. In some embodiments, for the first Computing Node CPN-1, the DAC engine (e.g., synchronizer) can also trigger it to as soon as an updated emission E is available (e.g., the DAC engine will check and inform CPN-1).

By the foregoing arrangement, the present system can ensure that Computing Nodes CPN-1, CPN-2 process the most current/updated data when computing or calculating, accordingly increasing overall system efficiency (e.g., avoid wasting computing resources on data that are not current or updated). In some embodiments, each data update event has a time stamp such that the DAC engine can make sure that the most recent data is used.

FIG. 1 is a schematic diagram illustrating nodes and their functions/roles in accordance with embodiments of the present technology. In the illustrated embodiments, a network 100 can include multiple “actor nodes.” In some embodiments, the actor nodes can include an entity or a device/machine/vehicle/appliance that performs a specific action in response to a data update.

As shown in FIG. 1, the network 100 can include four different types of roles, such as, (1) a producer node 101, (2) asset association nodes 103; (3) computing nodes 105, and (4) consumer nodes 107. In the illustrated embodiments, the network 100 includes one producer node 101, three asset association nodes 103A-C, two computing nodes 105A-B, and three consumer nodes 107A-C. In other embodiments, the network 100 can have different numbers of foregoing nodes in various cases.

In some embodiments, the producer node 101 can retrieve/collect/pull or even receive data from various data sources such as a data server, a sensor, a computer, a device, a vehicle, an appliance, a machine, a processor, a data storage (e.g., a memory, a disk drive, etc.), and other suitable devices. The producer node 101 pulls the data based on the asset association nodes 103 in the network 100. In the illustrated embodiments, there are three asset association nodes 103A-C. Each of the asset association nodes 103 indicates how a set of pulled data is to be processed.

In some embodiment, the present system can include a “virtual sensor” or a “virtual tag” (e.g., a set of instructions, application, software, firmware, etc.) associated with a data source. The virtual sensor is configured to modify or augment data from the data source. For example, a machine in a mining site can include a virtual sensor, which is configured to process data collected by the machine for further uses. In some embodiments, the virtual sensor can be configured to create a virtual event (e.g., a low pressure event of a component in the machine, a high temperature event of another component in the machine, etc.) for the purpose of triggering a notification or an action (e.g., trigger a result after a specific machine condition).

For example, the asset association node 103A indicates that a first set of data 11 is to be computed by computing node 105A to form a first set of computed data 11A. Both the first set of data 11 and the first set of computed data 11A are to be used or consumed by consumer node 107A. Similarly, the asset association node 103B indicates that a second set of data 12 is to be processed by computing node 105A to form a second set of computed data 12A and by computing node 105B to form a third set of computed data 12B. As also illustrated, the asset association node 103C indicates that a third set of data 13 is to be computed by computing node 105B and to form a fourth set of computed data 13B.

As shown in FIG. 1, both the second set of processed data 12A and the third set of computed data 12B are to be used or consumed by consumer node 107B. Similarly, both the third set of data 13 and the third set of computed data 13B are to be used or consumed by consumer node 107C.

In some embodiments, an edge device having a data-acquisition-and-computing (DAC) engine is configured to manage and coordinate the foregoing data processing/computing tasks. For example, in some embodiments, the DAC engine can communicate with multiple data sources and feed/direct particular data sets to the producer node 101. In some embodiments, the DAC engine can also check updates of the data and make sure that the pulled data is current.

In some embodiments, the asset association nodes 103A-C are configured to perform one or more data normalization/scaling processes. Embodiments of the data normalization/scaling processes include (1) identifying irregular data entries and adjusting identified irregular data entries (e.g., replacing by a predetermined value, such as a mathematical conversion in a previous data update); (2) verifying data entries (e.g., within upper and lower boundaries, compared to historical data, machine-trained data set, etc.); (3) formulating the data (e.g., adjusting format, unit converting, etc.) for further processes; (4) adjusting a range of the data (e.g., from raw data reading values to percentage values, “0” to “1” values, and/or other suitable ranges). The processed data can then be further computed at the computing nodes 105A-B so as to generate data for the consumer nodes 107A-C to use.

FIGS. 2A and 2B are schematic diagrams illustrating node operations/actions in accordance with embodiments of the present technology. In FIG. 2A, a network 200 includes one producer node 201, three asset association nodes 203A-C, two computing nodes 205A-B, and three consumer nodes 207A-C. As shown, the asset association node 203C indicates that a first set of data 21 is to be computed by computing node 205B to form a first set of computed data 21A for consumer node 207C. As also shown, the asset association node 203B indicates that a second set of data 22 is to be computed by computing node 205B to form a second set of computed data 22A for consumer node 207B. In the illustrated embodiments, generating the second set of computed data 22A requires the most recent first set of data 21, whereas generating the first set of computed data 21A also requires the most recent second set of data 22.

When a data-acquisition-and-computing (DAC) engine detects (e.g., via a configuration manager or by other suitable means) that there is an update for the first set of data 21, the configuration manager can initiate a reconfiguration process/sequence so as to make sure all “downstream” nodes (in the illustrated embodiment, 205B, 207B and 207C) of the asset association node 203C to are aware of such update and all corresponding actions/computation are on hold until the first set of data 21 is updated.

FIG. 2B illustrates a case where a new data set 209 is “dynamically” discovered/added or configured by the configuration manager to the network 200. During the operations discussed with reference to FIG. 2A, the configuration manager or via other methods can continue monitoring if there is any new data set added to the network 200. Assuming that the DAC engine is configured with the new data set 209 in the data source attached to Producer Node 201, which can include a third set of data 23, the DAC engine can be configured to integrate the third set of data 23 for computing the first set of computed data 21A and the second set of computed data 22A. Accordingly, a new asset association node 203D can be added to the network 200. The asset association node 203D indicates that the third set of data 23 is required for computing the first set of computed data 21A and the second set of computed data 22A by the computing node 205B. In some embodiments, the DAC engine can also indicate that the third set of data 23 is required for computing a third set of computed data 23A by a new computing node 205C. The third set of computed data 23A can then be used or consumed by a new consumer node 207D.

In some embodiments, when an update for the third set of data 23 is setup in configuration, a configuration manager can communicate with the asset association node 203C and the new asset association node 203D to make sure all of their “downstream” nodes (in the illustrated embodiment, 205B, 205C, and 207B-D) are configured to integrate and acknowledge such update. In some embodiments, all corresponding actions/computation are on hold until the third set of data 23 is updated. In some embodiments, similar operations can be implemented when an existing data source is considered currently unavailable. By the foregoing arrangement, the present system enables dynamic data configuration and operation management of the network 200.

FIG. 3 is a schematic diagram illustrating a data-acquisition-and-computing (DAC) engine 301 of a system 300 in accordance with embodiments of the present technology. As shown the system 300 also includes at least one data source 303, at least one data producer 313, at least one data association 315, and at least one data consumer 305. Producer nodes 313 are configured to retrieve data from the data source 303, other nodes will be configured to process and compute the retrieved data through a DAC Engine nodes network 306, and finally the DAC Engine 301 delivers the processed/computed data to the data consumer 305 for further use. In some embodiments, the processed/computed data can be transmitted to a data system 308 (e.g., an external data system) for further use. The system 300 can also include a data interface 304 used to host and provide data (e.g., via a configuration manager 302) to nodes in the DAC Engine nodes network 306 (e.g., asset association nodes 315, computing nodes 317 and consumer nodes 305), in the system 300.

As shown, the DAC engine 301 includes a processor 307, a memory 309, and a synchronizer (or a sampler) 311. In some embodiments, the DAC engine 301 can be implemented as an edge computing device. In some embodiments, the edge device can include for example, a machine, a computer, a client device, a server device, a distributed computing system, an appliance, a computing device that is capable of pulling data from various data sources and processing the data, etc. In some embodiments, the synchronizer or sampler 311 is configured to communicate with and manage the producer nodes 313, the asset association nodes 315, the computing nodes 317, and the consumer nodes 305, so as to ensure that the computations performed by these nodes are using the most current data from the data source 303. The synchronizer or sampler 311 is also configured to ensure that the computed data to be sent to the consumer nodes 305 is the most current.

In some embodiments, the synchronizer 311 can be configured to set and manage dependencies of the producer nodes 313, the asset association nodes 315, and the computing nodes 317, and the consumer nodes 305. The synchronizer 311 is configured to operate in a real-time or near real-time manner and to manage multiple nodes of the system 300 for signaling, sequencing, ordering, prioritizing, etc. The configuration manager 302 can cooperate with the synchronizer 311 and all nodes in the network 306 to manage data updates settings, configurations, idle/active/inactive statuses of the multiple nodes. In some embodiments, the configuration manager 302 does not operate in a real-time or near real-time manner, compared to the synchronizer 311. As shown in FIG. 3, the data interface 304 can be implemented in a memory (e.g., a volatile memory) and configured to serve as an interface for data transmission for the producer nodes 313, the asset association nodes 315, the computing nodes 317 and the consumer nodes 305. In some embodiments, the synchronizer 311 and the configuration manager 302 can be integrally implemented in a device. In other embodiments, however, the synchronizer 311 and the configuration manager 302 can be implemented in separated devices.

In some embodiments, the DAC engine 301 can communicate with the nodes in the network by a protocol such as MQTT (Message Queuing Telemetry Transport) protocol. In some embodiments, the DAC engine 301 can be configured to complete its communication with all nodes in the network within a predefined cycle (e.g., 0.5 second, 1 second, 10 seconds, etc.). In some embodiments, the DAC engine 301 can use a cycle identifier and/or a time stamp to track its communication with the nodes in the network 306.

In some embodiments, the DAC engine 301 can use a dependency tree as a reference when communicating with the nodes in the network. The dependency tree is indicative of how multiple nodes in a network are related to one another (e.g., when a set of data is updated, which nodes are affected). In such embodiment, the DAC engine 301 can implement a dependency policy to regulate the relationships among the nodes in the network (e.g., how adding a new node or dropping a node is going to affect the relationships among the nodes). The dependency policy is indicative of a processing/computing order of the multiple nodes (e.g., computing node N1 first and then node N2, etc.).

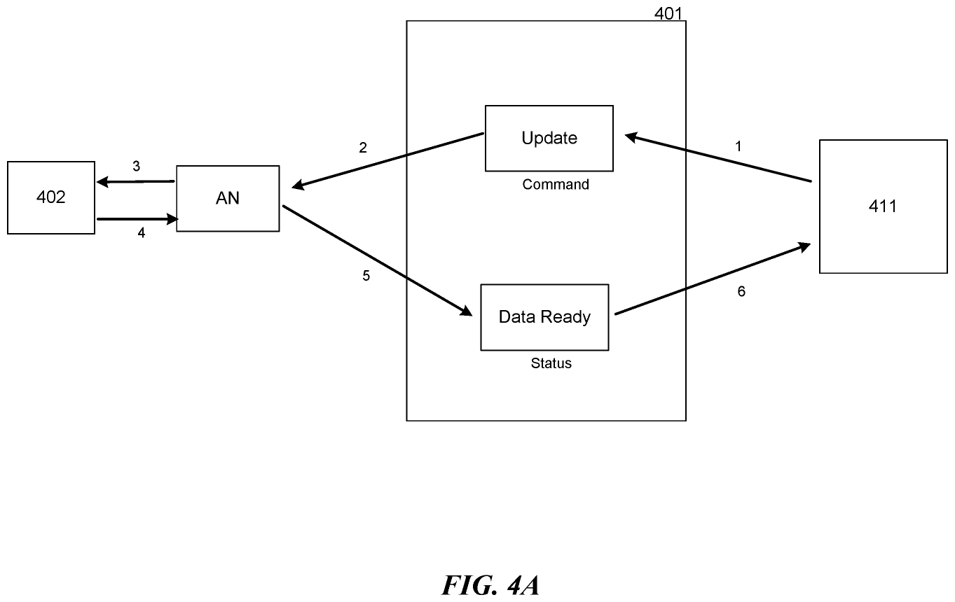

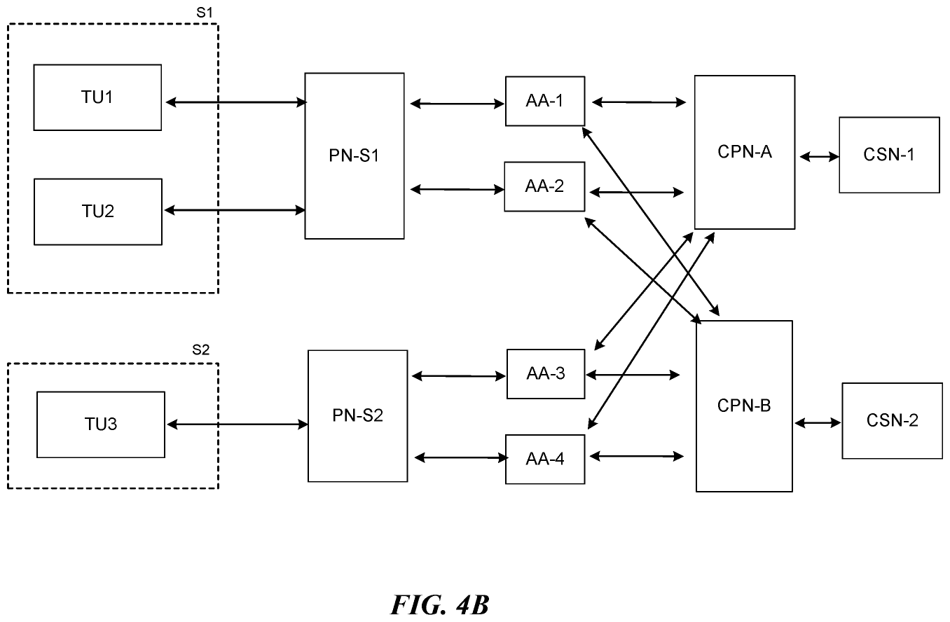

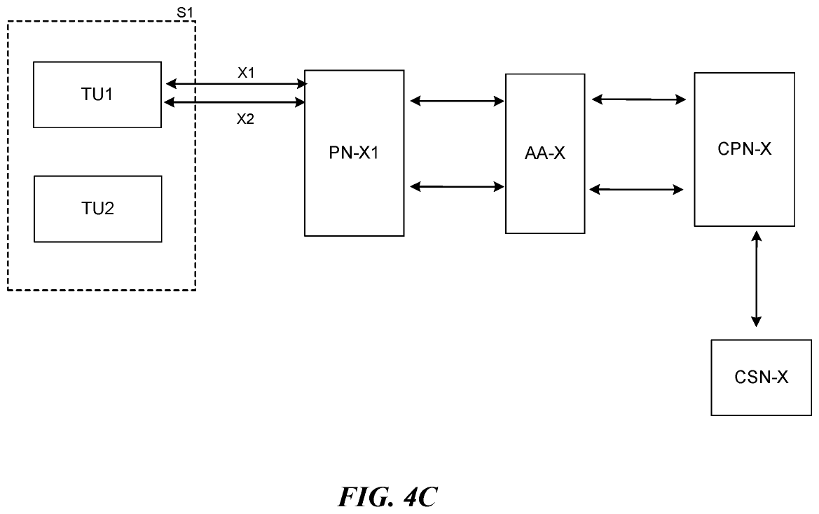

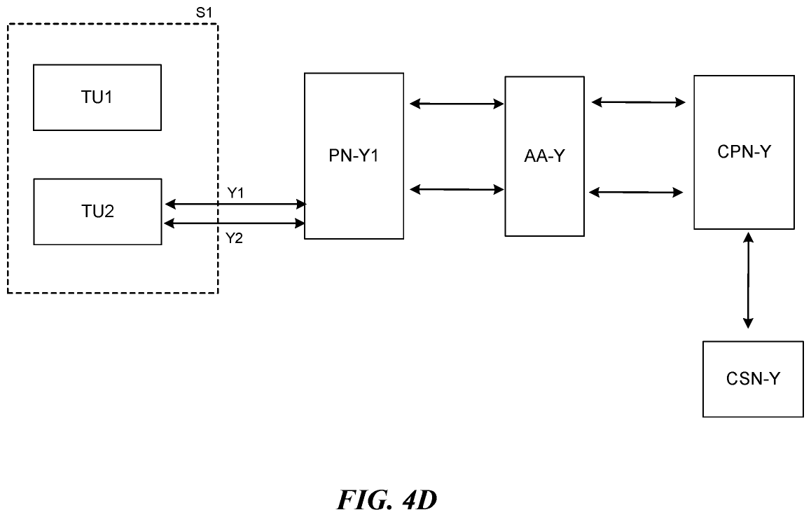

FIG. 4A is a schematic diagram illustrating operations of a feedback loop interface 401 in accordance with embodiments of the present technology. A synchronizer 411 first sends a command (Arrow 1) to the feedback loop interface 401 to trigger an update command or notice to an actor node AN. The feedback loop interface 401 then transmits the command to the actor node AN (Arrow 2). The actor node AN then performs an action or operation according to their nature and/or configuration, in some instance data elaboration and processing, normalization, computing or in some other instance communicates with a data source or data interface 402 to check if there is any data update and/or set an update (Arrow 3). The data source or data interface 402 responds to the actor node AN regarding the updated data or an acknowledgment, if any (Arrow 4). The actor node AN then transmits a status (Arrow 5) to the feedback loop interface 401. In some embodiments, the status update can include status indications such as “data update in progress,” “data ready (current, no updated needed),” “data updated complete,” etc. The feedback loop interface 401 then transmits the status to the synchronizer 411 (Arrow 6). In the illustrated embodiments, the feedback loop interface 401 provides an integrated interface for the synchronizer 411 to communicate with and manage multiple nodes in a network effectively and efficiently.

For illustrative purposes, three Use Cases are provided herein. These Use Cases involve industrial machines, vehicles, and devices such as gas turbines (hereafter “turbines”).

### Use Case A—Turbine Capacity Management

In this implementation, as depicted in FIG. 4B, the present system can be configured to monitor operations of multiple turbines, including Turbine Unit 1 (TU1), Turbine Unit 2 (TU2), and Turbine Unit 3 (TU3). TU1 and TU2 are located in industrial site S1, whereas TU3 is located in industrial site S2. Industrial sites S1 and S2 belong to a power plant. Producer Node PN-S1 can be configured to process data from TU1 and TU2. Producer Node PN-S2 can be configured to process data from TU3. The Producer Node PN-S1 can be configured to pull data for Asset Association Node AA-1 (e.g., operating capacity of TU1 in a first raw data form measured by a first sensor Sen1) and Asset Association Node AA-2 (e.g., operating capacity of TU2 in a second raw data form measured by a second sensor Sen2). The Producer Node PN-S2 can be configured to pull or receive data for Asset Association Node AA-3 (e.g., operating capacity of TU3 in a third raw data form measured by a third sensor Sen3) and Computing Node CPN-B can generate a data point relative to the plant (e.g., an average operating capacity of the plant).

The present system can include a first computing node CPN-A configured to calculate operating capacities of TU1, TU2, and TU3 (e.g., in percentages, such as 50% for TU1, 75% for TU2, and 85% for TU3). The present system can also include a second computing node CPN-B configured to an average operating capacity of the plant by averaging operating capacities of TU1, TU2, and TU3 (e.g., 70%). The first computing node CPN-A can then make available the calculated data (50% for TU1, 75% for TU2, and 85% for TU3) to a first consumer node CSN-1 for further processes. The second computing node CPN-B can then make available the calculated data (70% average capacity for the plant) to a second consumer node CSN-2 for further processes.

### Use Case B—Virtual Sensor for Turbine Emission Score

With an implementation similar to Use Case A, as depicted in FIG. 4C, the present system can be configured to create one or more “virtual sensors” for enhancing the data and/or create new data and/or eventually trigger any notification or action (e.g., triggering a result of a specific machine operation condition), augment or complement operations of TU1, TU2, and TU3. For example, Producer Node PN-X1 can be configured to pull two sets of data (e.g., Data X1 regarding an operating temperature and Data X2 regarding an operating pressure) from TU1 for Asset Association Node AA-X. Computing node CPN-X can then process Data X1 and Data X2 (e.g., by selecting Data X1 and/or Data X2 in a specific time interval, such as ten minutes) and generate a processed data set (e.g., Data X3). The processed data set can then be made available to a consumer node CSN-X for further processes (e.g., to calculate a turbine emission score).

### Use Case C—Virtual Event for Turbine Operations

With an implementation similar to Use Case A, as depicted in FIG. 4D, the present system can be configured to create one or more “virtual events.” In some embodiments, the present system can combine multiple conditions to create another specific condition. For example, the present system can include Producer Node PN-Y1 configured to pull two sets of data (e.g., Data Y1 indicating whether a vent is open or closed; Data Y2 regarding a suction pressure) from TU2 for Asset Association Node AA-Y. Computing node CPN-Y can then process Data Y1 and Data Y2 (e.g., when Data Y1 indicates that the vent is open and Data Y2 shows that the suction pressure is larger than a threshold) and generate a processed data set (e.g., Data Y3, indicating a blow-down event). The processed data set can then be sent to a consumer node CSN-Y for further processes (e.g., to initiate, simulate or notify the blow-down event).

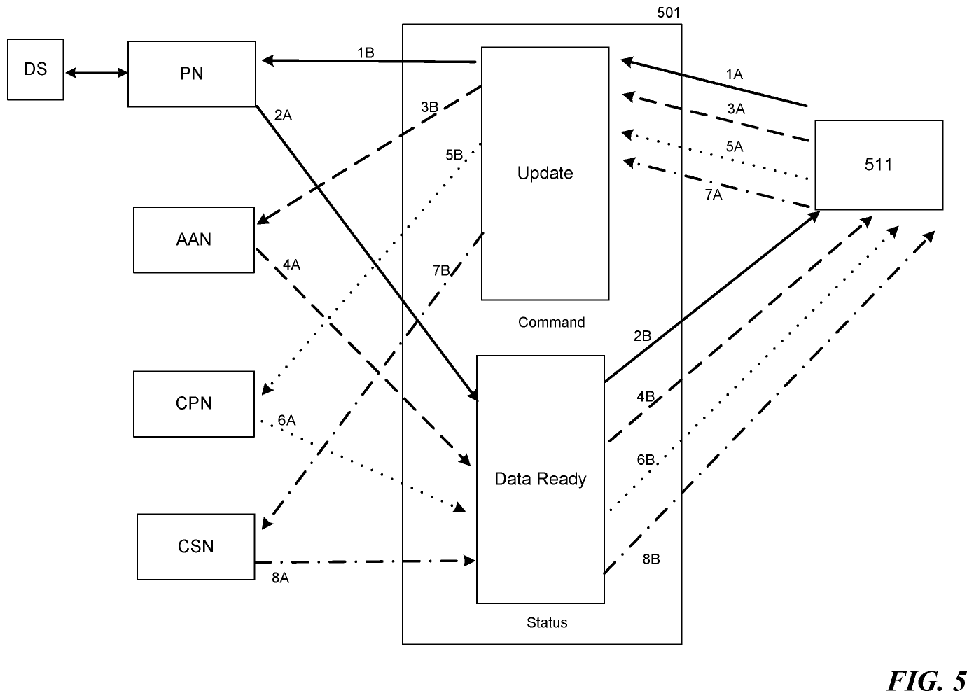

FIG. 5 is a schematic diagram illustrating operations of a feedback loop interface 501 for multiple nodes in a network in accordance with embodiments of the present technology. As shown in FIG. 5, a synchronizer 511 first sends a command (Arrow 1A) to the feedback loop interface 501 to trigger an update or check if there is any update for an actor node producer PN. The feedback loop interface 501 then transmits the command to the actor node producer PN (Arrow 1B). The actor node producer P then transmits a status (Arrow 2A) to the feedback loop interface 501. In some embodiments, the status update can include “data update in progress,” “data ready (current, no updated needed),” “data updated complete,” etc. The feedback loop interface 501 then transmits an indication of the status to the synchronizer 511 (Arrow 2B).

Similarly, the feedback loop interface 501 can function as an integrated interface for the synchronizer 511 to communicate with and manage other nodes in the network. As illustrated, the synchronizer 511 can send a command (Arrow 3A) to the feedback loop interface 501 to trigger an update or check if there is any update for a data asset association node AAN. The feedback loop interface 501 then transmits the command to the data asset association node AAN (Arrow 3B). The data association node AAN then transmits a status (Arrow 4A) to the feedback loop interface 501. The feedback loop interface 501 then transmits the status to the synchronizer 511 (Arrow 4B).

Similarly, the synchronizer 511 can send a command (Arrow 5A) to the feedback loop interface 501 to trigger an update or check if there is any update for a computing node CPN. The feedback loop interface 501 then transmits the command to the data computing node CPN (Arrow 5B). The computing node CPN then transmits a status (Arrow 6A) to the feedback loop interface 501. The feedback loop interface 501 then transmits the status to the synchronizer 511 (Arrow 6B).

Similarly, the synchronizer 511 can send a command (Arrow 7A) to the feedback loop interface 501 to trigger an update or check if there is any update for a consumer node CSN. The feedback loop interface 501 then transmits the command to the consumer node CSN (Arrow 7B). The consumer node CSN then transmits a status (Arrow 8A) to the feedback loop interface 501. The feedback loop interface 501 then transmits the status to the synchronizer 511 (Arrow 8B).

By the foregoing arrangement, the present system provides an integrated interface (e.g., the feedback loop interface 501) for the synchronizer 511 to communicate with and manage multiple nodes in the network effectively and efficiently. In some embodiments, the feedback loop interface 501 can be implemented as a set of instructions, or as an application, stored in the edge device that includes the synchronizer 511. In some embodiments, the feedback loop interface 501 can be included in the data-acquisition-and-computing (DAC) engine that includes the synchronizer 511. In some embodiments, for example, the DAC engine can perform sequences in a recurring cycle by following a hierarchy of nodes in a network (e.g., first producer nodes PN, followed by data asset association nodes AANs, data computing node CPN, and then consumer nodes CSN). The dependencies of these nodes are also considered through processing the data association nodes AANs. As also shown in FIG. 5, the producer nodes PN, the data asset association nodes AANs, and the data computing node CPN can communicate with a data interface or a data source DS.

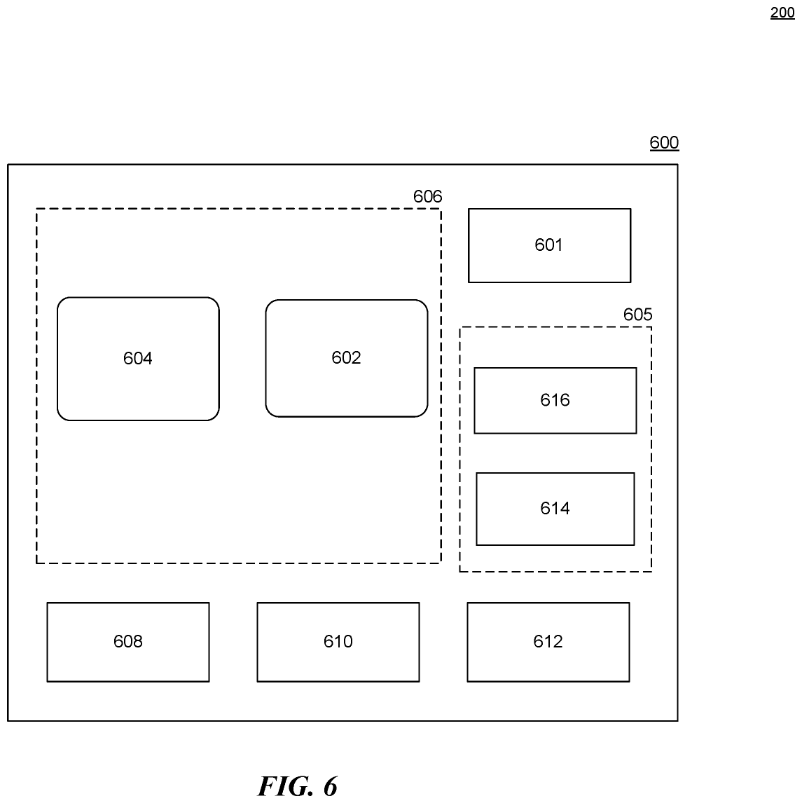

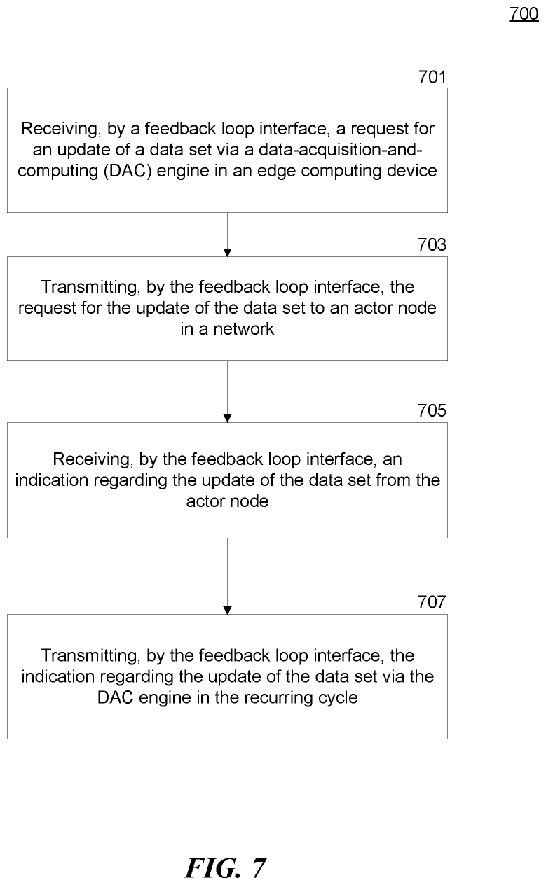

FIG. 6 is a schematic diagram illustrating components in a computing device (e.g., an edge computing device) in accordance with embodiments of the present technology. The computing device 600 can be used to implement methods (e.g., FIG. 7) discussed herein. The computing device 600 can be used to perform the processes/operations discussed in FIGS. 1-5. Note the computing device 600 is only an example of a suitable computing device and is not intended to suggest any limitation as to the scope of use or functionality. Other well-known computing systems, environments, and/or configurations that may be suitable for use include, but are not limited to, personal computers (PCs), server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, the computing device 600 includes at least one processing unit 602 and a memory 604. Depending on the exact configuration and the type of computing device, the memory 604 may be volatile (such as a random-access memory or RAM), non-volatile (such as a read-only memory or ROM, a flash memory, etc.), or some combination of the two. This basic configuration is illustrated in FIG. 6 by dashed line 606. Further, the computing device 600 may also include storage devices (a removable storage 608 and/or a non-removable storage 610) including, but not limited to, magnetic or optical disks or tape. Similarly, the computing device 600 can have an input device 614 such as keyboard, mouse, pen, voice input, etc. and/or an output device 616 such as a display, speakers, printer, etc. Also included in the computing device 600 can be one or more communication components 612, such as components for connecting via a local area network (LAN), a wide area network (WAN), cellular telecommunication (e.g. 3G, 4G, 5G, etc.), point to point, any other suitable interface, etc.

The computing device 600 can include a wear prediction module 601 configured to implement methods for operating the machines based on one or more sets of parameters corresponding to components of the machines in various situations and scenarios. For example, the wear prediction module 601 can be configured to implement the wear prediction process discussed herein. In some embodiments, the wear prediction module 601 can be in form of tangibly stored instructions, software, firmware, as well as a tangible device. In some embodiments, the output device 616 and the input device 614 can be implemented as the integrated user interface 605. The integrated user interface 605 is configured to visually present information associated with inputs and outputs of the machines.

The computing device 600 includes at least some form of computer readable media. The computer readable media can be any available media that can be accessed by the processing unit 602. By way of example, the computer readable media can include computer storage media and communication media. The computer storage media can include volatile and nonvolatile, removable and non-removable media (e.g., removable storage 608 and non-removable storage 610) implemented in any method or technology for storage of information such as computer readable instructions, data structures, program modules or other data. The computer storage media can include, an RAM, an ROM, an electrically erasable programmable read-only memory (EEPROM), a flash memory or other suitable memory, a CD-ROM, digital versatile disks (DVD) or other optical storage, magnetic cassettes, magnetic tape, magnetic disk storage or other magnetic storage devices, or any other tangible medium which can be used to store the desired information.

The computing device 600 includes communication media or component 612, including non-transitory computer readable instructions, data structures, program modules, or other data. The computer readable instructions can be transported in a modulated data signal such as a carrier wave or other transport mechanism and includes any information delivery media. The term “modulated data signal” means a signal that has one or more of its characteristics set or changed in such a manner as to encode information in the signal. By way of example, and not limitation, the communication media can include wired media such as a wired network or direct-wired connection, and wireless media such as acoustic, radio frequency (RF), infrared and other wireless media. Combinations of any of the above should also be included within the scope of the computer readable media.

The computing device 600 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections can include any method supported by available communications media. Such networking environments are commonplace in offices, enterprise-wide computer networks, intranets and the Internet.

FIG. 7 is a flow diagram showing a method 700 in accordance with embodiments of the present technology. The method 700 can be implemented by an edge computing device discussed herein. The method 700 starts at block 701 by receiving, by a feedback loop interface, a request for an update of a data set via a data-acquisition-and-computing (DAC) engine in an edge computing device. Embodiments of the DAC engine can be found in FIG. 3 and related descriptions. In some embodiments, the DAC engine can include a synchronizer configured to control sequences in a recurring cycle of a nodes network. In some embodiments, the synchronizer can be configured via a configuration manager or receive configuration from actor nodes in the network for managing the data set.

At block 703, the method 700 continues by transmitting, by the feedback loop interface, the request for the update of the data set to an actor node in the network. In some embodiments, the actor node can be a producer node, and the producer node can be configured to retrieve or receive the data set from one or more data sources. In some embodiments, the actor node can be an asset association node, and the asset association node is configured to indicate one or more nodes (e.g., a computing node, a consumer node, etc.) in the network for processing the update of the data set in the nodes network.

In some embodiments, the asset association node can be further configured to perform a data normalization process on the data set, in response to the update of the data set. For example, the data normalization process can include (1) identifying irregular data entries in the data set and adjusting identified irregular data entries; (2) verifying data entries associated with the dataset based on a threshold; (3) adjusting a format of the data set; (4) converting a unit of the data set; and/or (5) adjusting a range of the data set.

At block 705, the method 700 continues by receiving, by the feedback loop interface, an indication regarding the update of the data set from the actor node. At block 707, method 700 continues by transmitting, by the feedback loop interface, the indication regarding the update of the data set via the DAC engine in the recurring cycle. In some embodiments, the indication can a signal showing the result of the action such as a change of a data set, and the indication can be used as an index to retrieve data update (e.g., via a data interface, as discussed herein with reference to FIG. 3.)

In some embodiments, the data set can be a first data set. The request can be a first request. The actor node can be a first actor node. The indication can be a first indication. The update can be a first update. The method 700 can further comprise: (i) receiving, by the feedback loop interface, a second request for a second update of a second data set via the DAC engine in the edge computing device; (ii) transmitting, by the feedback loop interface, the second request for the second update of the second data set to a second actor node in the network; (iii) receiving, by the feedback loop interface, a second indication regarding the second update of the second data set from the second actor node; and (iv) transmitting, by the feedback loop interface, the second indication regarding the second update of the second data set via the DAC engine in the recurring cycle.

In some embodiments, the second actor node can include an asset association node, a computing node, or a consumer node in the network. In some embodiments, the method 700 can further comprise holding off a computing process performed by the computing node until receiving a confirmation from the synchronizer of the DAC engine that the first update and the second update are complete.

In some embodiments, the asset association node is further configured to perform a data normalization process on the data set, in response to the update of the data set. In some embodiments, the data normalization process can include at least one of the following: (1) verifying data entries associated with the data set based on a threshold; (2) adjusting a format of the data set; (3) converting a unit of the data set; and (4) adjusting a range of the data set.

In some embodiments, the computing node can be further configured to generate and elaborate new data in response to the update of the data set. The data generating and elaborating process includes at least one of the following: (i) performing arithmetic of mathematical operations; (ii) evaluating one or more conditional statement; (iii) evaluating or computing mathematical function or models; (iv) evaluating or computing statistical function or models; (v) evaluating or computing time-series models; (vi) evaluating or computing programable code functions; and (vii) evaluating or computing a machine learning function or a derivative function.

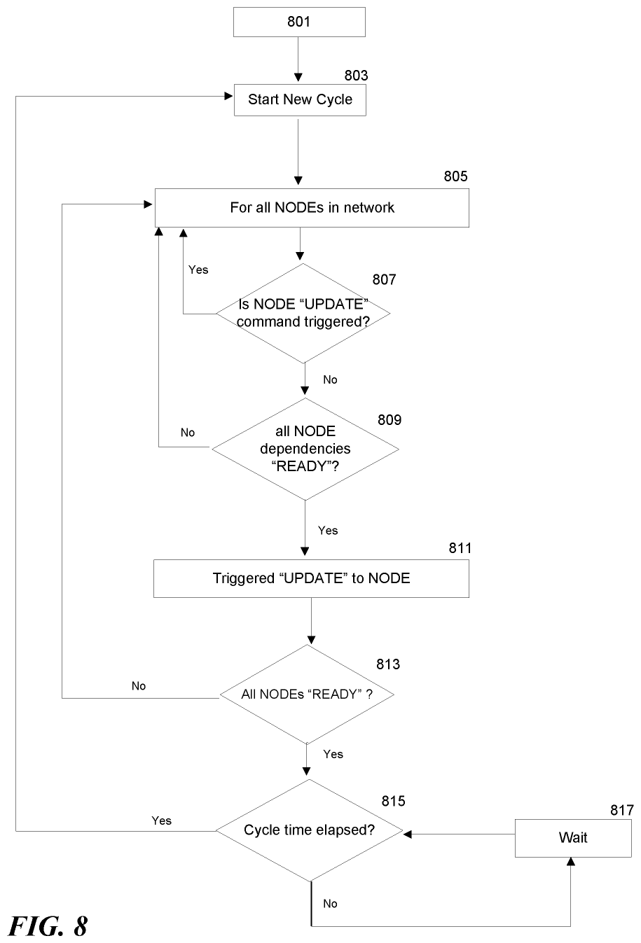

FIG. 8 is a flow diagram showing operations of a synchronizer 801 or sampler in accordance with embodiments of the present technology. The synchronizer 801 performs sequences described in FIG. 8 so as to check of there is any update for multiple nodes in a network. At block 803, the synchronizer 801 starts a new recurring cycle with a cycle time. At block 805, in the recurring cycle, the synchronizer 801 performs processes described in blocks 807, 809, 811, 813, 815 and 817, until predefined conditions (e.g., yes/no determined by decision blocks 807, 809, 813, and 815) are met. Then the synchronizer 801 moves to the next cycle (i.e., going back to block 803).

More particularly, at block 807, the synchronizer 801 checks if there is any “UPDATE” command triggered for the node that is currently processed (i.e., “processing node”). If so, the process moves to the next node. If not, the process moves to block 809 to check if the “dependencies” of the processing node is “READY” (i.e., all data required for further processes is ready/current and not need for further waiting). If so, the process moves to block 811 to trigger updates for the processing node. If not, the process goes back to block 805 to process the next node. At block 813, once the processing node is updated at block 811, the process determines if all nodes are “ready.” If so, the process moves to block 815 to see if the cycle time is elapsed. If not, the process moves to block 817 and wait for the cycle time to elapse. If yes, the process then moves back to block 803 to start the next cycle.

For an identified node that is “ready,” the process goes to block 809 and checks if all “dependent information” related to that node are ready. Embodiments of the “dependent information” can include information needed for further processes or computations, such as node status, node operating parameters, measurements, etc. In some embodiments, the “dependent information” can be updates from other nodes. If all the “dependent information” is ready to go, the synchronizer 801 can prepare to process and send the update (e.g., to all downstream nodes that are affected by the update). In some embodiments, there can be multiple updates or other information to be sent to one node. In such embodiments, the update can be stored in a temporary space, combined with other information, and sent via an update command.

### INDUSTRIAL APPLICABILITY

The systems and methods described herein can effectively communicate with and manage multiple nodes (e.g., machines in a work site) in a network regarding data synchronization and update. The methods enable an operator, experienced or inexperienced, to effectively manage data synchronization for the multiple nodes without duplicate data computation/processing so as to reduce interrupting the ongoing tasks of the multiple nodes. The present systems and methods can also be implemented to manage multiple industrial machines, vehicles and/or other suitable devices such as excavators, etc.

The above description and drawings are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” (or the like) in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. It will be appreciated that the same thing can be said in more than one way. Consequently, alternative language and synonyms may be used for any one or more of the terms discussed herein, and any special significance is not to be placed upon whether or not a term is elaborated or discussed herein. Synonyms for some terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the claims are not to be limited to various embodiments given in this specification. Unless otherwise defined, all technical and scientific terms used herein have the same meaning as commonly understood by one of ordinary skill in the art to which this disclosure pertains. In the case of conflict, the present document, including definitions, will control.

As used herein, the term “and/or” when used in the phrase “A and/or B” means “A, or B, or both A and B.” A similar manner of interpretation applies to the term “and/or” when used in a list of more than two terms.

The above detailed description of embodiments of the technology are not intended to be exhaustive or to limit the technology to the precise forms disclosed above. Although specific embodiments of, and examples for, the technology are described above for illustrative purposes, various equivalent modifications are possible within the scope of the technology as those skilled in the relevant art will recognize. For example, although steps are presented in a given order, alternative embodiments may perform steps in a different order. The various embodiments described herein may also be combined to provide further embodiments.

From the foregoing, it will be appreciated that specific embodiments of the technology have been described herein for purposes of illustration, but well-known structures and functions have not been shown or described in detail to avoid unnecessarily obscuring the description of the embodiments of the technology. Where the context permits, singular or plural terms may also include the plural or singular term, respectively.

As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number, respectively. Additionally, the term “comprising” is used throughout to mean including at least the recited feature(s) such that any greater number of the same feature and/or additional types of other features are not precluded, unless context suggests otherwise. It will also be appreciated that specific embodiments have been described herein for purposes of illustration, but that various modifications may be made without deviating from the technology. Further, while advantages associated with some embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein. Any listing of features in the claims should not be construed as a Markush grouping.

1. A non-transitory, computer-readable storage medium storing instructions which, when executed by at least one data processor of a computing system, cause the computing system to:
receive, by a feedback loop interface, a request for an update of a data set via a data-acquisition-and-computing (DAC) engine in an edge computing device, wherein the DAC engine includes a synchronizer configured to control sequences in a recurring cycle of a network, and wherein the synchronizer is configured to communicate with a configuration manager or receive configuration information from nodes in the network for managing the data set;
transmit, by the feedback loop interface, the request for the update of the data set to an actor node in the network;
receive, by the feedback loop interface, an indication regarding the update of the data set from the actor node; and
transmit, by the feedback loop interface, the indication regarding the update of the data set via the DAC engine in the recurring cycle.

2. The medium of claim 1, wherein the actor node is a producer node, wherein the producer node is configured to retrieve or receive the data set from one or more data sources, and wherein the data set is generated from a sensor of a turbine.

3. The medium of claim 2, wherein the actor node is an asset association node, and wherein the asset association node is configured to associate one or more additional data sets from the producer node in the network for processing the update of the data set.

4. The medium of claim 3, wherein the actor node is a computing node, and wherein the computing node is configured to generate a new data to complement the data set.

5. The medium of claim 3, wherein the actor node is a computing node, and wherein the computing node is configured to process or elaborate data according to a nature of the computing node or the configuration information received to generate a new data to complement the data set.

6. The medium of claim 3, wherein the actor node is a computing node, wherein the computing node is configured to process or elaborate data according to data set dependencies to generate a new data to complement the data set.

7. The medium of claim 3, wherein the actor node is a computing node, and wherein the computing node is configured to perform arithmetic of mathematical operations.

8. The medium of claim 3, wherein the actor node is a computing node, wherein the computing node is configured to evaluate one or more conditional statement, mathematical function or models, statistical function or models, time-series models, programable code functions, and a machine learning or derivative function.

9. The medium of claim 3, wherein the asset association node is further configured to perform a data normalization process on the data set via the configuration manager, in response to the update of the data set.

10. The medium of claim 7, wherein the data normalization process includes one or more of the following:
identifying irregular data entries in the data set and adjusting identified irregular data entries;
verifying data entries associated with the dataset based on a threshold;
adjusting a format of the data set;
converting a unit of the data set; and
adjusting a range of the data set.

11. The medium of claim 3, wherein the nodes in the network include a consumer node.

12. The medium of claim 1, wherein the data set is a first data set, wherein the request is a first request, wherein the actor node is a first actor node, wherein the indication is a first indication, wherein the update is a first update, and wherein the method further comprises:
receiving, by the feedback loop interface, a second request for a second update of a second data set via the DAC engine in the edge computing device;
transmitting, by the feedback loop interface, the second request for the second update of the second data set to a second actor node in the network;
receiving, by the feedback loop interface, a second indication regarding the second update of the second data set from the second actor node; and
transmitting, by the feedback loop interface, the second indication regarding the second update of the second data set to via the DAC engine in the recurring cycle.

13. The medium of claim 12, wherein the second actor node includes an asset association node in the network.

14. The medium of claim 12, wherein the second actor node includes a computing node in the network.

15. The medium of claim 14, further comprising holding off a computing process performed by the computing node until receiving a confirmation from the DAC engine that the first update and the second update are complete.

16. The medium of claim 12, wherein the second actor node includes a consumer node in the network.

17. A system comprising:
a processor;
a memory communicably coupled to the processor, the memory comprising computer executable instructions that, when executed by the processor, cause the system to:
receive a request for an update of a data set via a data-acquisition-and-computing (DAC) engine in an edge computing device, wherein the DAC engine includes a synchronizer configured to control sequences in a recurring cycle of a network, and wherein the synchronizer is configured to communicate with a configuration manager or receive configuration information from nodes in the network for managing the data set, wherein the data set is available via a data interface;
transmit the request for the update of the data set to an actor node in the network;
receive an indication regarding the update of the data set from the actor node; and
transmit the indication regarding the update of the data set via the DAC engine in the recurring cycle.

18. The system of 17, wherein the actor node is an asset association node, and wherein the asset association node is configured to associate one or more computing nodes and consumer nodes in the network for computing the update of the data set.

19. The system of 18, wherein the asset association node is further configured to perform a data normalization process on the data set, in response to the update of the data set, wherein the data normalization process includes at least one of the following:
verifying data entries associated with the data set based on a threshold;
adjusting a format of the data set;
converting a unit of the data set; and
adjusting a range of the data set; and
wherein the computing node is further configured to generate and elaborate new data in response to the update of the data set, wherein the data generating and elaborating process includes at least one of the following:
performing arithmetic of mathematical operations;
evaluating one or more conditional statement;
evaluating or computing mathematical function or models;
evaluating or computing statistical function or models;
evaluating or computing time-series models;
evaluating or computing programable code functions;
evaluating or computing a machine learning or derivative function.

20. A method for data synchronization, comprising:
receiving, by a feedback loop interface, a first request for a first update of a first data set via a data-acquisition-and-computing (DAC) engine in an edge computing device;
receiving, by the feedback loop interface, a second request for a second update of a second data set via the DAC engine in the edge computing device, wherein the DAC engine includes a synchronizer configured to control sequences in a recurring cycle of a network, and wherein the synchronizer is configured to communicate with a configuration manager or receive configuration information from nodes in the network for managing the first and second data sets;
transmitting, by the feedback loop interface, the first request for the first update of the first data set to a first actor node in the network;
transmitting, by the feedback loop interface, the second request for the second update of the second data set to a second actor node in the network;
receiving, by the feedback loop interface, a first indication regarding the first update of the first data set from the first actor node;
receiving, by the feedback loop interface, a second indication regarding the second update of the second data set from the second actor node;
transmitting, by the feedback loop interface, the first indication regarding the first update of the first data set to the synchronizer of the DAC engine; and
transmitting, by the feedback loop interface, the second indication regarding the second update of the second data set to the synchronizer of the DAC engine,
wherein the synchronizer is configured to transmit a confirmation to a third actor node indicating that the first update and the second update are complete, in response to the first indication and the second indication.
